(19) United States
(12) Patent Application Publication
(10) Pub. No.: US 2011/0233294 A1
(43) Pub. Date: Sep. 29, 2011

(54) LIQUID INJECTOR FOR A COMBUSTION ENGINE

(76) Inventors: Michael Dirk Boot, Eindhoven (NL); Jos Johannes Egidius Reijnders, Bakel (NL)

(21) Appl. No.: 13/123,004

(22) PCT Filed: Oct. 12, 2009
(86) PCT No.: PCT/NL2009/000195

§ 371 Date: Jun. 3, 2011

(30) Foreign Application Priority Data
Oct. 10, 2008 (NL) 2002079

(51) Int. Cl. F02M 61/00

(52) U.S. Cl. 239/1; 239/533.2

(57) ABSTRACT

A liquid injector has an injector body provided with an injection passage which is formed by the cavity between the inner wall of the injector body and a needle and the cavity in a hole located in the wall of the injector body. The liquid injector has a spherical, hollow porous element which extends beyond the injector body and is formed by a semi-sphere which is fixed to the injector body and closes off the injection passage. The wall thickness of the porous element is not the same throughout. In the middle the wall is thinner than near the edge, so that during the injection action the fuel vapour has the shape of a semi-ellipse.

### FIELD OF THE INVENTION

The invention relates to a liquid injector for injecting liquid fuel into a combustion chamber.

The liquid injector comprises an injector body with an injection passage as well as a porous element which is connected to the injector body and closes off the injection passage, which element comprises a solid material having a network of mutually connected pores.

The invention more particularly relates to a liquid injector for direct injection of liquid fuel into the cylinders of the combustion engine, more especially in diesel engines. The porous element may be for example a sintered material or a foam-like material or a porous material found in nature.

By injecting fuel through a porous element having a pore size smaller than 50 micrometers, the fuel is vaporized better (which is to say that smaller droplets are created) than by injecting the fuel through a multiplicity of minute channels having a diameter of 150 micrometers. This provides a more complete combustion and thus leads to less formation of smuts. In addition, a lower fuel pressure will suffice with this so that the injection system can be manufactured in a more cost efficient manner.

### STATE OF THE ART

A liquid injector generally of this type is known from DE-A-4200710. The porous element in this known liquid injector is located in the injection passage at a hole in the wall of the tip of the liquid injector. In consequence the vaporized fuel which is injected by the liquid injector during operation has a conical shape.

As a consequence of this conical shape of the fuel vapour not the complete cavity of the combustion chamber in the cylinder and/or in the piston can be filled with fuel, so that the air present in the combustion chamber is not used to the full.

### SUMMARY OF THE INVENTION

It is an object of the invention to provide a liquid injector of the type defined in the opening paragraph in which the cavity in the combustion chamber is used in a better manner. To this end the liquid injector according to the invention is characterised in that the porous element extends at least partly beyond the injector body. As a result the cone angle of the fuel vapour is larger than in the known liquid injector so that the cavity in the combustion chamber is used in a better manner.

It should be observed that from US-A-2005/0193984 is known a gas injector with also a porous element extending beyond the injector body. However, that patent is about a gas injector and not a liquid injector. The object and effect of this porous element also completely differs from that of the present invention. First and foremost in this known gas injector gaseous fuel is injected to the injector body as a result of which the element does not function for vaporizing liquid. Furthermore, the function of this element is not to spread the fuel as uniformly as possible in a combustion chamber. As a consequence of the two said differences a solution for the problem posed above will not be found in the field of gas injectors.

It should further be observed that from US-A-2007/204836 and EP-A-1 302 635 liquid injectors are known having an element that comprises a plurality of holes for vaporizing and distributing liquid fuel in a combustion chamber. However, in that version the holes are formed by bores and not by a continuous network of pores.

At any rate the portion of the porous element extending beyond the injector body is preferably spherical. In this context a spherical portion is understood to be a more or less spherical bulge extending beyond the injector body. With a spherical combustion chamber in the piston the complete cavity in the combustion chamber is filled with the fuel vapour so that all air present is used up during the combustion.

Furthermore, at any rate the portion of the porous element extending beyond the injector body is preferably hollow and is provided with an intake opening which is connected to the injection passage. In consequence, the fuel spreads out better in sideways direction than with a solid porous element.

For application to combustion engines in which the combustion chambers do not exactly have the shape of a sphere an embodiment of the liquid injector according to the invention is characterised in that the wall thickness of the portion of the porous element extending beyond the injector body is not equally large throughout. The suitable wall thickness variation over the spherical shape of the porous element can be instrumental in obtaining substantially any form of fuel vapour.

The invention also relates to a liquid injection system for injecting liquid fuel into a combustion chamber, comprising a liquid pump as well as a liquid injector according to the invention and connected to the liquid pump.

Furthermore, the invention relates to a method of injecting liquid fuel into a combustion chamber. With regard to the method the invention is characterised in that the liquid is pressed into the combustion chamber through a porous element, which element comprises a solid material provided with a network of mutually connected pores.

An embodiment of the method according to the invention is characterised in that the liquid is pressed into the combustion chamber through a porous element, of which element at any rate the portion extending beyond the injector body is hollow and is provided with an intake opening which is connected to the injection passage.

A further embodiment of the method according to the invention is characterised in that the liquid is pressed into the combustion chamber through a porous element, of which element the wall thickness of the portion of the porous element extending beyond the injector body is not equally large throughout.

Yet a further embodiment of the method according to the invention is characterised in that the liquid is pressed into the combustion chamber through a porous element, of which element at any rate the wall thickness of the portion of the porous element extending beyond the injector body is spherical.

### BRIEF DESCRIPTION OF THE DRAWINGS

The following description relating to the appended drawings, the whole given by way of non-limiting example of the liquid injector according to the invention, will provide better understanding of how the invention can be realised, in which:

FIG. 1 shows a first embodiment of the liquid injector according to the invention;

FIG. 2 shows a detailed view of the tip of the liquid injector together with the fuel vapour;

FIGS. 3 to 6 show the various phases during the reconstruction from a known liquid injector to an liquid injector according to the invention; and

FIG. 7 shows a second embodiment of the liquid injector according to the invention.

### DETAILED DESCRIPTION OF THE DRAWINGS

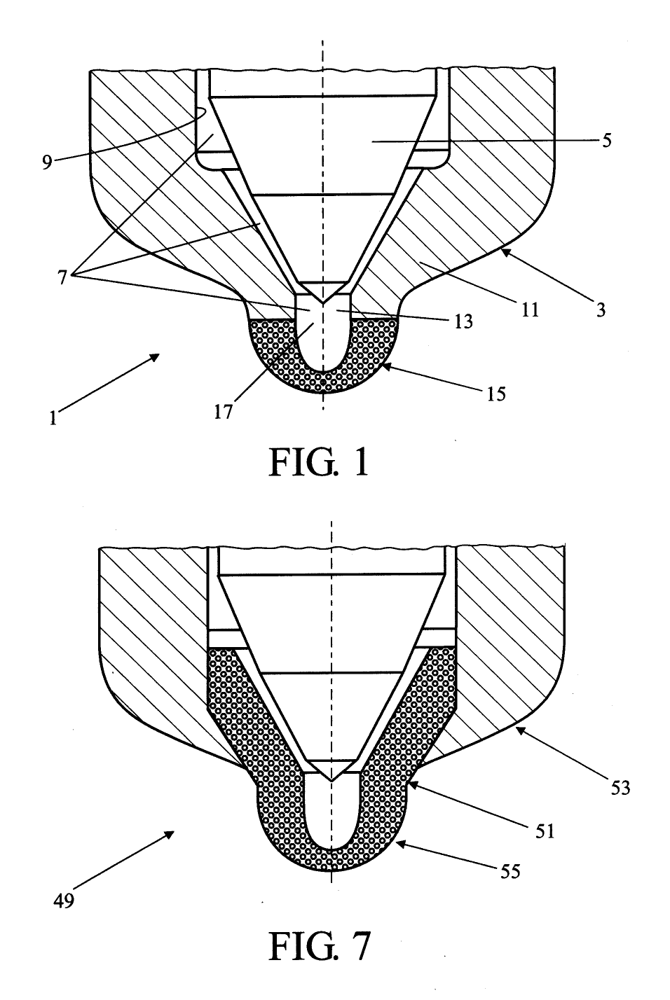

FIG. 1 shows a first embodiment of the liquid injector according to the invention in longitudinal section. The liquid injector 1 has an injector body 3 with a needle 5 located inside which is moved to the depicted location against the pressure of a spring (spring is not shown) as a result of the fuel pressure prevailing in the injector body cavity. The injector body 3 has an injection passage 7 which is formed by the cavity between the interior wall 9 of the injector body and the needle 5 and the cavity in a hole 13 provided in the wall 11 of the injector body.

The liquid injector 1 further includes a spherical, porous element 15 which extends beyond the injector body 3 and is formed by a semi-sphere which is fixed to the injector body and closes off the injection passage 7. The porous element 15 has a pore size of less than 50 micrometers and has an intake opening 17 which is connected to the injection passage 7.

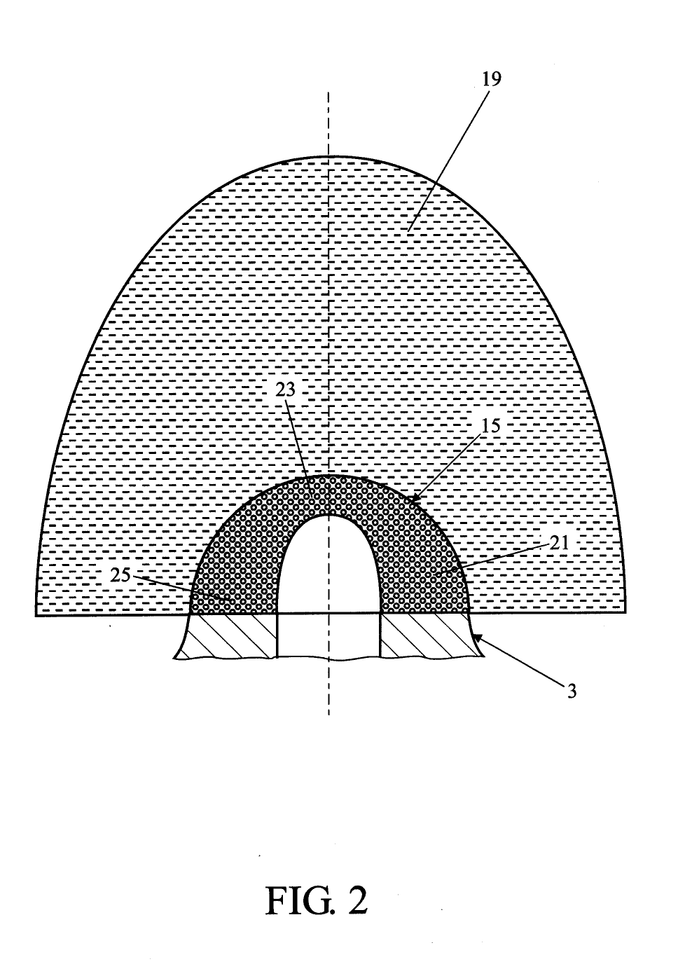

FIG. 2 shows an enlarged view of the tip of the liquid injector in which the shape of the fuel vapour 19 formed during the injection is represented. The wall 21 of the porous element 15 is not equally thick throughout. In the middle 23 the wall thickness is less than near the edge 25. As a result the fuel in the middle will experience less resistance than near the edge, so that the fuel in the middle is injected into the cylinder at more power than near the edge and the fuel vapour 19 has the shape of a semi-ellipse.

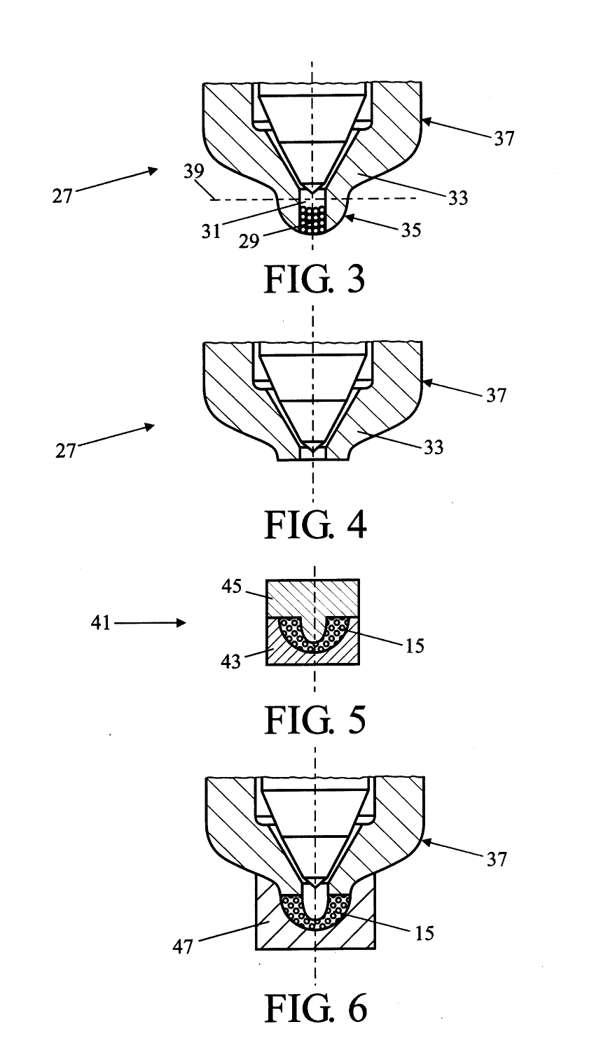

FIGS. 3 to 6 show the various phases during the reconstruction from a known liquid injector 27 to the liquid injector 1 according to the invention. FIG. 3 shows the known liquid injector 27 in which the porous element 29 is located in a hole 31 in the wall 33 of the tip 35 of the injector body 37. In the first step the tip of the injector is removed along line 39. FIG. 4 shows the liquid injector 27 without a tip.

The new porous element 15 is manufactured in a mould 41 by means of sintering. This is shown schematically in FIG. 5. The mould consists of two mould halves 43 and 45 which enclose a cavity of which the shape corresponds to that of the porous element. The porous element 15 is for example made of stainless steel or ceramics. Then the new porous element 15 is fixed to the injector body 37. This is also achieved by means of sintering and is schematically shown in FIG. 6. In this Figure a mould 47 is placed against the injector body 37.

FIG. 7 shows a second embodiment of the liquid injector 49 according to the invention. In this Figure the porous element 51 is present in the form of an insert which is fixed inside the injector body 53 while only a portion 55 of the porous element extends to beyond the injector body.

Although the invention has been described in the foregoing based on the drawings, it should be observed that the invention is not by any manner or means restricted to the embodiment shown in the drawings. The invention also extends to all embodiments deviating from the embodiment shown in the drawings within the spirit and scope defined by the claims.

1. A liquid injector for injecting liquid fuel into a combustion chamber, the liquid injector comprising:
an injector body with an injection passage; and
a porous element which is connected to the injector body and closes off the injection passage, the porous element comprising a solid material having a network of mutually connected pores, the porous element extending at least partly beyond the injector body.

2. A liquid injector as claimed in claim 1, wherein a portion of the porous element extending beyond the injector body is hollow and is provided with an intake opening which is connected to the injection passage.

3. A liquid injector as claimed in claim 2, wherein the portion of the porous element extending beyond the injector body includes a wall thickness that is not equally large throughout.

4. A liquid injector as claimed in claim 1, wherein a portion of the porous element extending beyond the injector body is spherical.

5. A liquid injector system for injecting liquid fuel into a combustion chamber, the liquid injector system comprising:
a liquid injector comprising an injector body with an injection passage, and a porous element which is connected to the injector body and closes off the injection passage, the porous element comprising a solid material having a network of mutually connected pores, the porous element extending at least partly beyond the injector body; and
a liquid pump connected with the liquid injector.

6. A method of injecting liquid fuel into a combustion chamber, the method comprising the steps of:
providing a liquid injector for injecting liquid fuel into a combustion chamber, the liquid injector comprising an injector body with an injection passage, and a porous element which is connected to the injector body and closes off the injection passage, the porous element comprising a solid material having a network of mutually connected pores, the porous element extending at least partly beyond the injector body; and
pressing the liquid into the combustion chamber through the porous element.
